(19) United States
(12) Patent Application Publication
(10) Pub. No.: US 2002/0183975 A1
(43) Pub. Date: Dec. 5, 2002

(54) Method and apparatus for passively monitoring of a vehicle during distribution of fluid products thereto

(76) Inventor: Jack A. Wiens, San Jose, CA (US)

Correspondence Address: OPPENHEIMER WOLFF & DONNELLY, P. O. BOX 10356, PALO ALTO, CA, 94303, US

(21) Appl. No.: 09/872,693

(22) Filed: Jun. 1, 2001

(51) Int. Cl. G06F 15/00; G06F 17/40

(52) U.S. Cl. 702/187

(57) ABSTRACT

A method and apparatus for passively monitoring the distribution of fuel and lubrication fluids to track vehicles and other heavy duty work equipment, such as bulldozers, draglines, scrapers, loaders, etc. The system includes means for identifying and recording the identity of the dispensing vehicle, the dispensing operator, the location of the dispensing vehicle, the receiving vehicle, the receiving port on the receiving vehicle, the type of fluid dispensed, the quantity of fluid dispensed, and the time of the dispensing. The system also includes means for verifying that the proper fluid is dispensed to the appropriate port. Use of the system does not in any way interfere with the servicing operations.

### FIELD OF THE INVENTION

The present invention relates generally to the distribution of products and more particularly to a method for passively monitoring distribution of fluid products and the like.

### BACKGROUND OF THE INVENTION

Due to the strenuous tasks heavy equipment is frequently required to perform, and the fact that such tasks are usually performed at locations remote from the garage or maintenance yard at which the equipment is based, fuel, fluids and certain lubricating resources must be delivered to the work site in order to maintain the life span of this heavy equipment. Equipment of the type often referred to as track or mobile equipment vehicles, or stationary equipment, may include machinery such as tractors, bulldozers, earthmovers, etc. These track vehicles are normally serviced at the work site by product delivery and resource vehicles, called lube vehicles or lube trucks.

Lube vehicles typically include an assortment of tanks, pumps, hoses and attaching connections or fittings for dispensing the materials, which may include fuel, oils, greases, water, etc. Further, the lube vehicles may include an assortment of tanks and hoses for collecting waste or reclaimable products. The tank sizes often range from 30 to 2000 gallons or more.

Frequently, a plethora of track vehicles are serviced by a single lube truck and often, two or more lube trucks service several mobile equipment vehicles in the same general area. These scenarios often result in several people being associated with the lube vehicles servicing several mobile equipment vehicles during one visit to the vehicle work site location. Consequently, it is often difficult to monitor whether the correct materials (e.g. fuels, oils, greases, water, etc.) are being dispensed in the proper quantity to the correct receptacle. Further, the environments associated with these situations also result in difficulty of tracing the distributor, as well as recording the amounts of the distribution. It is also important for the personnel, operators, owners and management of the mobile equipment being serviced to identify the location and identity number or designation of the particular piece of mobile equipment to which the fluids are dispensed.

### SUMMARY OF THE INVENTION

Accordingly, it is an object of the present invention to provide an improved method and system for monitoring distribution of consumable product to heavy duty work equipment.

Another object of the present invention is to provide a product distribution monitoring system that decreases the record keeping burden on the operator of a supply vehicle.

A further object of the present invention to provide a means for alerting an operator of an incorrect product distribution.

It is yet another object of the present invention to provide a means for signaling an operator during distribution to validate and acknowledge correct product distribution to various ones of a plurality of discrete product reservoirs.

Still another object of the present invention is to provide identification of the vehicles, persons, and receptacles associated with the product distribution.

Briefly, a preferred embodiment of the present invention provides a method and apparatus for passively monitoring the distribution of fuel and lubrication fluids to track or mobile equipment vehicles or stationary equipment and other heavy duty work equipment, such as bulldozers, draglines, scrapers, loaders, etc. The system includes means for identifying and recording the identity of the dispensing vehicle, the dispensing operator, the location of the dispensing vehicle, the receiving vehicle, the receiving port on the receiving vehicle, the type of fluid dispensed, the quantity of fluid dispensed, and the time of the dispensing. The system also includes means for verifying that the proper fluid is dispensed to the appropriate port. Use of the system does not in any way interfere with the normal servicing operations.

An advantage of the present invention is that it provides a system for passively monitoring the dispensing activity of a fluids servicing vehicle as it replenishes heavy equipment fluids reservoirs and delivers lubricants to specified required points.

Another advantage of the present invention is that it provides a system for assisting the operator of a heavy equipment servicing vehicle with records keeping.

Still another advantage of the present invention is that it provides a means for instantaneously verifying that the port to which a particular fluid is applied correctly corresponds to that intended.

A further advantage of the present invention is that it provides substantially all of the records keeping input required for efficient operation of a product distribution vehicle without in any way increasing the operator workload or interfering with the normal conduct of the dispensing operation.

These and other objects and advantages of the present invention will become clear to those skilled in the art upon review of the following specification, the accompanying drawings and the appended claims.

### BRIEF DESCRIPTION OF THE DRAWINGS

The invention will be better understood when consideration is given to the following detailed description thereof, such description making reference to the annexed drawings wherein:

FIG. 1 is a diagram schematically illustrating components of an embodiment of the present invention as applied to a track vehicle or other mobile vehicle or stationary equipment and a lube truck dispensing fluids thereto; and

FIG. 2 is a schematic illustration representing use of an alternative embodiment similar to that of FIG. 1 in association with multiple lube trucks and track or other mobile vehicles or stationary equipment;

FIG. 3 is a broken perspective view illustrating a simplified ID plate in accordance with the present invention;

FIG. 4 is a perspective view showing a hand held ID plate reader in accordance with the present invention;

FIG. 5 is a transverse cross section taken through the plane 5-5 in FIG. 4; and

FIG. 6 is a flowchart illustrating a process for passively monitoring distribution of products in accordance with the present invention.

### BEST MODE FOR CARRYING OUT THE INVENTION

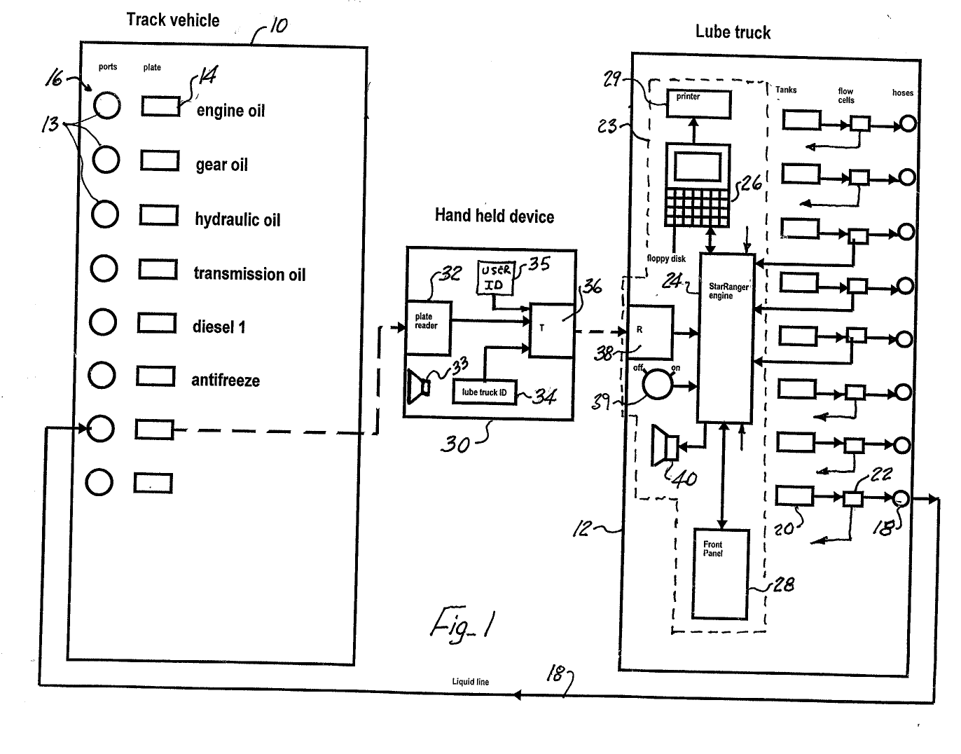

Referring now to the drawings, a preferred embodiment of the present invention is illustrated schematically in FIG. 1. In this figure, the components included in a monitoring system carried on a lube truck and an identifying plate carried on a track vehicle in accordance with the present invention are depicted. Although “track vehicle” is used throughout the application, the vehicle may be any other mobile vehicle or stationary equipment suitable for use with the present invention. The track vehicle 10 includes a plurality of fittings or ports 13, in some cases arranged in an array or group 16, for receiving fluids or other products from the truck 12. In accordance with use of the present invention, an ID plate 14 associated with the particular type of product to be dispensed received by a particular port is affixed to the vehicle 10 proximate the corresponding port.

As will be further explained below, each ID plate will carry a machine readable code identifying the track vehicle, the port, and the type of fluid to be dispensed into the associated port. The lube truck 12 includes a plurality of hoses 18 that distribute the fluid product from corresponding tanks 20 that store each product. Flow cells 22 gauge the amount distributed from each tank 20 to its associated hose 18 and ultimately to a particular port 13 in the track vehicle 10. The amount of product that the flow cells 22, or flow measurement devices, measure as having been distributed is normally retained in counters and/or communicated to some type of data collecting system. However, although the quantities of the fluids or other products distributed are measured, no means is usually provided to assure that the fluids were properly distributed to the proper vehicle, or the proper port on a particular vehicle. It is this deficiency in the prior art that is addressed by the present invention.

More specifically, in accordance with the present invention a passive monitoring system is provided which includes a programmable monitoring unit 23, a handheld sensor device 30, and a plurality of ID plates 14 mentioned above. The monitoring unit 23 may include a computer 24, which may be accessed by an operator through another computer, such as a laptop 26, or a front panel 28 with a keypad for allowing an operator to communicate with the computer, a printer 29, a receiver 38, an on/off switch 39, and a horn 40. The computer 24 is adapted to separately monitor the operation of each flow cell 22 and record the quantity of fluid passing therethrough from a tank 20 to a hose 18. Where a flow meter, or flow cell, does not exist on the lube truck, an appropriate flow measuring device may be installed at each hose line on the lube truck. Computer 24 also compares flow cell ID (which is associated with a particular tank and therefore identifies the type of fluid supplied to a particular hose 18) to the (type of) fluid identity read from the ID plate associated with the port 13 to which the hose 18 is connected, and if the two do not match it causes the horn 40 to sound and a record of the incident including all inputs is preserved.

A handheld device 30 is provided for extracting information from each ID plate 14. Included in the handheld device 30 are an ID plate reader 32, a lube truck identifier 34, and an operator identifier 35, as well as a transmitter 36. The transmitter 36 sends information from the ID plate reader 32 and the lube truck identifier 34 to the receiver 38 included in the lube truck 12. The receiver 38, in turn, routes the information to the computer 24 in the lube truck 12. The computer 24 may communicate a signal to a horn 40, or some other type of annunciator that will emit a sound confirming or denying distribution of the correct product to a particular port 13 in the track vehicle 10. Alternatively, the hand held device may include a sound emitting device 33 for emitting a sound which can be matched or otherwise related to the lube truck signal. Note that since the subject apparatus is entirely passive and does not perform any control function, the operator may choose to ignore the alarm warning of distribution of a product to the wrong port and continue to distribute the product despite the alarm warning. However, as will be discussed below, his error will be tracked and recorded and he may subsequently be called upon to explain his oversight or intentional misdeed.

The ID plates 14 on a given track vehicle may number from one to sixteen, enabling the monitoring of up to 16 products in the preferred embodiment. Each ID plate includes a product identifier, a track vehicle identifier, and a port identifier. Preferably, the ID plate is comprised of metal with an array of magnet receiving aperture formed therein. As discussed below, particular combinations of magnets are possible. Some of the apertures may have magnets embedded therein and some apertures may be without magnets. Furthermore, some of the magnets may be polarized opposite to others. In any event, the array in each ID plate is configured to present a readable code uniquely identifying the three items indicated above. The metal in which the apertures are formed may be of aluminum, steel, etc. Alternatively, the ID plate may include a barcode or any other form of identifier encoded to identify the three items listed above. In a preferred embodiment, the plate covers several square inches and is less than 0.25 inches thick. Further, one of the several plates may be utilized to identify a port at which engine run hours may be read.

In a preferred embodiment of the present invention, the computer may utilize StarRanger ViewPro software of the type manufactured by Scientronix, Inc. of San Jose, Calif.

One or more hand held reader devices may be associated with the lube vehicle carrying unit. Preferably, there are two reader devices, one for the operator of the lube vehicle and one for the journeyman. In this embodiment, both the operator and the journeyman would be assigned a personal reader device preprogrammed to output a lube truck identifying code and a user identifying code. In use, the hand held device is held against the particular ID plate, thereby extracting the identifiers encoded on the track vehicle plate. The data is then transmitted to the receiver on the lube truck unit along with the operator/journeyman ID.

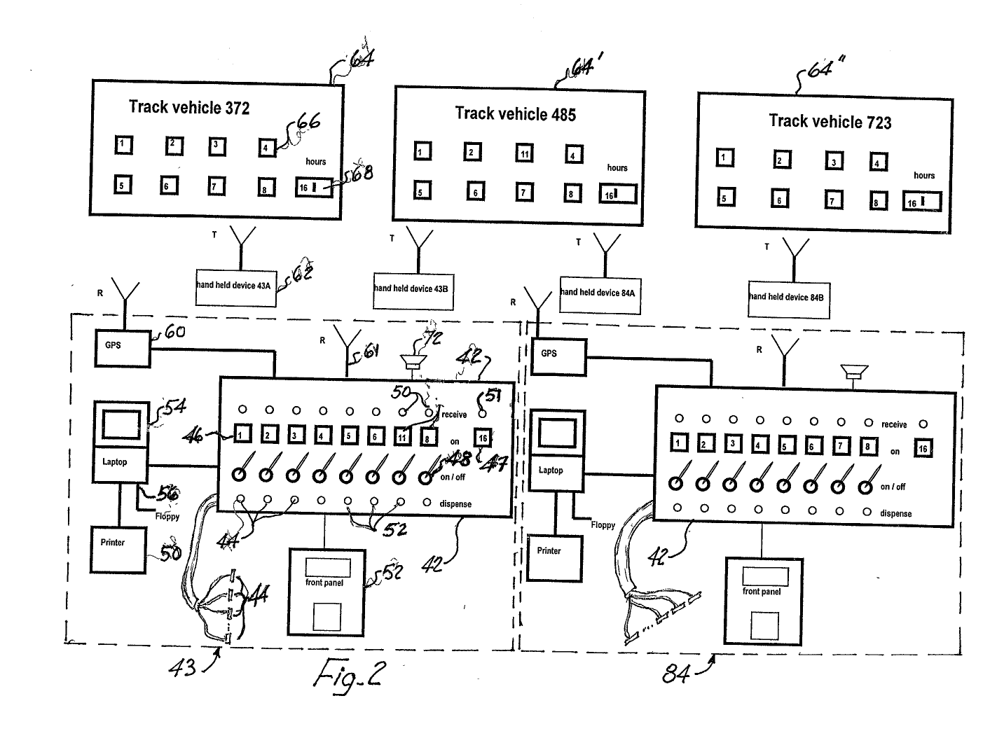

FIG. 2 is a schematic illustration of multiple lube truck units 42 replenishing multiple track vehicles 64 located in, for example, a storage yard or a marshalling area at a larger job site. Two lube trucks, each of which has a unique ID (43, 84), are suggested by the dashed boxes. Although not shown, each lube truck includes storage tanks, pumps, flow metering devices, and hoses similar to that depicted in FIG. 1. In addition, the trucks may include fluid collection tanks and associated plumbing and housing (also not shown) to allow recoverable materials such as spent oils, coolants, etc., to be collected and returned for recycling or environmentally safe disposal.

In this embodiment, the housings for the units 42 include suitable cabling including a bundle of flow signal carrying lines leading to a plurality of jacks or sensors for connection to the respective flow control and measurement devices on the carrying lube truck for extracting flow information relating to each supply and collection hose. The housing face may include a plurality of hose line identifiers, or indicators, 46 a corresponding plurality of on/off switches 48 for selectively activating and disabling (turning off) each flow signal line, an upper row of indicators 50, each corresponding to one of the hose identifiers 46 and operative when illuminated to indicate that the corresponding hose is receiving (accepting) fluids, and a similar lower row of indicators 52, each corresponding to and associated with one of the hose lines to indicate that its corresponding hose is dispensing fluid. One of the indicators 46 designated 47 in FIG. 2 is a non-dispense/collection indicator and corresponds to sensory input indicating the engine run time of a track vehicle being serviced. Its associated indicator light 51 merely indicates that the engine run time sensor is active.

Each lube truck unit 42 also includes a front panel 52 for allowing the entry of information, a laptop 54 unit including a floppy disk drive 56 and a printer 58, and a global positioning system (GPS) 60 for generating and inputting a location signal. The GPS signal indicates the position of the vehicle, as well as the time associated with that position. Each unit 42 is equipped with a handheld device 62 for the operators associated with a particular lube truck. Each hand held device 62 includes means for entering an ID associated with the operator and/or journeyman as pointed out above. One or more lube trucks may service multiple track vehicles 64.

As also discussed above, the track vehicles 64 include ID plates 66 encoded to identify and provide information about the track vehicle and the particular port being accessed by the lube truck operator. At least one identifier plate 68 on the track vehicle includes means for indicating engine run time hours and thus is not associated with a fill or collection port.

The identifier plates on each track vehicle may be color coded. The nozzle on the pump on each hose from the lube truck may be color coded to correspond to the identifier plate affixed next to the appropriate port. This type of color-coding system may assist the operator in connecting the correct hose to the correct port by matching the nozzle color to the color of the identifier plate on the track vehicle. Any such matching system may help to ease the operator's task.

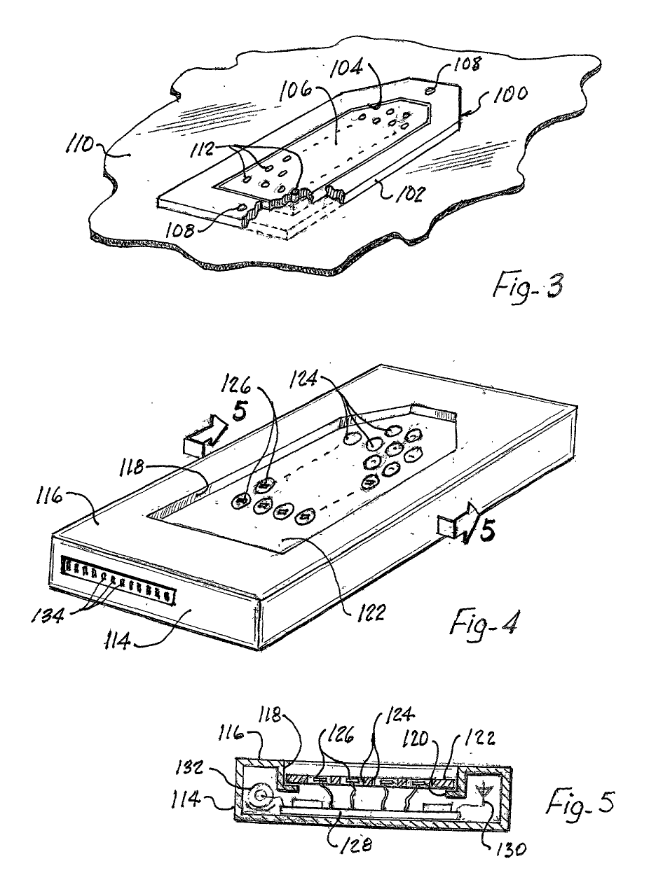

FIG. 3 is a broken perspective view showing an embodiment of ID plate in accordance with the present invention. As illustrated plate 100 is actually an assembly including an outer frame 102 having a six-sided aperture 104 provided therein for receiving a six-sided code plate 106. Frame 102 may be of metal, plastic, or any other suitable material and may be provided with a pair of screw or rivet holes 108 for use in affixing it to a flat panel 110 of a track vehicle. The outer perimeter is made six-sided to facilitate proper alignment with a reader device. It is of course to be understood that any other suitable perimeter design could be used.

Code plate 106 is likewise configured to have an outer perimeter corresponding to the shape of aperture 104 so that when the code plate is installed in the frame 102, it too will be properly aligned. The code plate 106 may be retained within the frame 102 using any suitable mechanical or adhesive fastening means. A suitable adhesive coating applied to the back surface is the preferred fastener.

Plate 106 is provided with an array of cylindrical openings 112 for receiving a plurality of cylindrical magnets that when appropriately positioned and/or oriented (polarized), in predetermined areas of the plate, they will collectively evidence codes that identify (1) the track vehicle, and (2) the port to which the ID plate is associated. The type of material or product that is to be introduced into or removed from the reservoir linked to the port is identified in a data table associated with the port. Alternatively, the position of the magnets may evidence codes that identify the material or product that is to be introduced into or removed from the reservoir linked to the port. The magnets may be any shape suitable for use with the present invention. For magnet and plate material details of a similarly coded device, reference is made to the U.S. Pat. No. 3,995,145 of Harris, III, the entire disclosure of which is expressly incorporated herein by reference.

Any other method of coding the ID plate may be utilized that is suitable for use with the present invention. For example, the code may be electromagnetically coupled into a magnetizable strip or strips contained in or affixed to the ID plate. Similarly, a bar code or the like may be utilized.

Turning now to FIG. 4, a code reader in accordance with the present invention is depicted at 114 with its bottom side 116 facing upwardly. The reader 114 is essentially a rectangular or other suitably shaped container for housing reading and transmitting electronics components and includes a six-sided opening 118 for mating with the ID frame 102 shown in FIG. 3. As is shown more clearly in FIG. 5, which is a transverse cross sectional view taken through reader 114 in the plane 5-5 of FIG. 4, the opening 118 terminates in inwardly extending flanges 120 disposed within the volume of space defined by the container walls and forms a seat for a reader plate 122.

Reader plate 122 is formed of any suitable plastic or metallic material and has an array of openings 124 formed therein with the centers of the openings being substantially aligned with the center-lines of the magnets 112 of ID plate 106. The diameters of the openings 124 are however somewhat larger than the diameters of their magnetic cylinders so as to provide receptacles within which Hall-effect sensors or other magnetic field responsive devices 126 may be mounted. Positional within container 114 and beneath plate 122 is a circuit board 128 that carries electrical components capable of converting electrical outputs generated by the sensors 126 into the coded signals read from an ID plate, and for transmitting such signals via an internal antenna 130 back to the lube vehicle receiver. Alternatively, the antenna may be external. Power for the reader is supplied by batteries 132. However, any other charging source that is suitable for use with the present invention, such as a vibration charging mechanism, may be utilized to supply power to the reader. The lube truck ID and operator ID may be input to the electronics by means of micro-switches 134 that can be preset at the time it is assigned to the operator. The switches may be externally accessible as illustrated, or may be internal and inaccessible to the user of the device. Further, any other method of inputting coding to the electronics suitable for use with the present invention may be utilized.

In operation, one or more operators from the lube truck take a dispensing hose or a receiving hose to a track vehicle. The operator connects the dispensing hose or the receiving hose to a port located on the track vehicle and positions his reader device over the corresponding identifier plate 66 on the track vehicle and an ID signal is transmitted to the lube truck unit as the operator commences the fill or extraction operation. Transmission may be via radio waves, light (such as infrared), audio, or any other suitable means of communication. Only the operators' lube truck will accept the transmitted signal from the hand held device 62 and the horn 72 on the lube truck will sound to indicate that the dispensing hose or receiving hose is attached to the correct or incorrect port. If the hose is attached to the wrong port, an alarm will sound and the product may or may not continue to be dispensed, depending on the conduct of the operator. In other words, since the present invention is passive and does not control operation of the lube truck servicing, the product may continue to be dispensed should the operator ignore the alarm and leave the switch in the on position. However, the truck unit 42 will record all such information associated with the transaction.

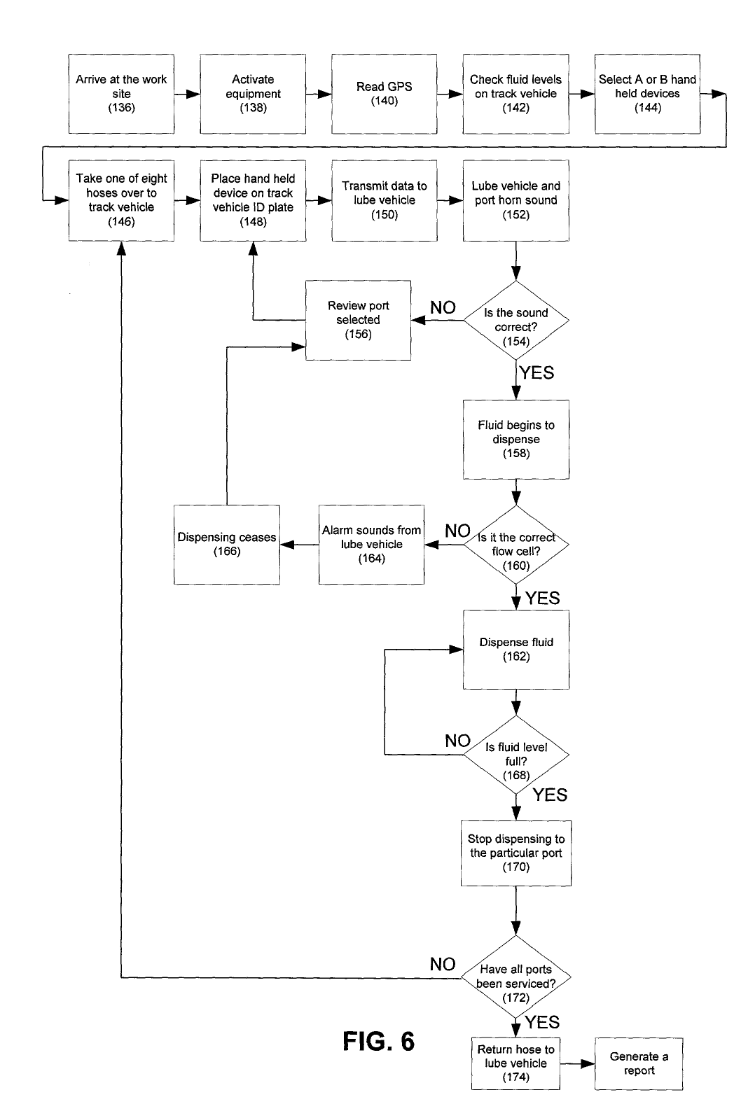

FIG. 6 is a flowchart illustrating the process of delivering a product in accordance with an embodiment of the present invention. In this example, a lube vehicle operator and journeyman arrive at the work site (Block 136). The operator activates the control system and the subject monitoring system carried on the lube truck (Block 138). The position of the lube vehicle is read by a global positioning system (“GPS”) (Block 140). The operator and journeyman check the fluid levels on the track vehicle (Block 142) and select one of the hand held devices on the lube vehicle (Block 144). The operator or journeyman, or both, take one of the lube truck hoses over to the track vehicle (Block 146), connects the hose to a port, and places his hand held device on the ID plate located on the track vehicle next to the port (Block 148). The data from the ID plate, and that included in the hand held device itself, such as operator ID, is transmitted back to the lube vehicle (Block 150). In this embodiment, the lube vehicle sounds a horn frequency corresponding to the particular hose (type product) being used, followed by a horn frequency corresponding to the product type intended to be provided to the particular port identified by the track vehicle ID plate (Block 152). If both sounds match (Block 152), the operator causes the fluid to be dispensed from the lube vehicle to the track vehicle (Block 154). Alternatively, the hand held device may emit a sound which can be matched or otherwise related to the lube truck signal. The signal may have the same frequency as the signal emitted from the lube vehicle, and further, the signal may be specific to the particular port. Thus, ports are matched to a memorized sound. If the sounds do not match (Block 152), the operator (or journeyman) reviews the port selected (Block 156) and again places his hand held device on the ID plate located on the track vehicle next to the port (Block 148). The operator may choose the same port or a different port, depending on whether he believes he made a mistake or that the system experienced a transmission error. The information will be retransmitted when the hand held device is reapplied to the plate and the process is repeated (Blocks 148, 150, and 152).

Once the fluid begins to dispense (Block 158), the system checks to see if it is being dispensed from the correct flow cell (Block 160). If the fluid is being dispensed from the correct flow cell, the fluid continues to be dispensed (Block 162). If the fluid is not being dispensed from the correct flow cell, an alarm sounds from the lube vehicle (Block 164) and the operator causes the dispensing of the fluid from the flow cell to cease (Block 166). The operator again reviews the port selected (Block 156) and connects the hose to a different port, if appropriate, until the system confirms a correct connection.

As fluid is dispensed, the system periodically asks whether the “full” fluid level has been reached (Block 168). If the full fluid level is reached, the operator stops dispensing fluid to the particular port (Block 170). If the full fluid level has not been reached, the operator will continue to dispense fluid (Block 162). The system asks whether all the ports have been serviced (Block 172). When all the ports have been serviced, the hose is returned to the lube vehicle (Block 174). If the fluid level at a particular port is not full when the supply available from the currently used hose is exhausted, the operator will return the hose to the vehicle and, if available, use another hose dispensing the same fluid and continue the dispensing process (Block 162).

Once all of the fluid levels are full, the operator will return the hose to the lube vehicle, and a report may be generated. The report may include the track vehicle ID, port IDs and port flow and “wrong port” alarm, lube vehicle ID, operator or journeyman ID, site location, run time hours, the date, and start and stop time. The operator can review the report, and if the readings on the report are good, the operator can turn off, or deactivate, the equipment. If the report includes bad readings, or print errors, the operator can make notes that reflect these errors. A floppy disk, or telephonic medium or any other suitable means, may be utilized to transfer the data to an enterprise system at another location.

Each lube truck port may be assigned a separate level in the software program. Since levels execute asynchronously, multiple products can be delivered at the same time. When the controller receives the start transaction digital signal, the level associated with that digital input will become active and save the analog values from the track vehicle in integer variables and real variables that are used only be that level. A formula will add 0.5 to round off each real variable that has to be treated as a whole number.

When the data from the ID plate on the track vehicle is transmitted from the hand held device to the lube truck, the receiver parses the data and attributes it to the appropriate port. The track vehicle information is stored in the controller.

When the operator finishes dispensing the product, an end of transaction signal is sent to the controller. A signal is sent to the computer to log the information stored in the controller for that particular port. The controller can keep running totals of the amounts of fluids delivered at each port.

Each product may be logged to a separate file. For example, if a lube truck includes eight dispenser ports, there may be eight files. Each record may represent a transaction, such as gas fill up, etc.

While various alternatives have been described above, it should be understood that the present invention has been presented by way of example only, and not limitation. Thus, the breadth and scope of the invention should not be limited by any of the above described exemplary embodiments, but should be defined only in accordance with the following claims.

What is claimed is:

1. A method for passively monitoring the servicing of a vehicle during distribution of fluid products thereto, comprising the steps of:
(a) obtaining a first set of data associated with a particular vehicle port to be serviced;
(b) determining whether or not said first set of data identifies a particular port intended to be serviced and generating a signal commensurate therewith;
(c) obtaining a second set of data associated with distribution of a product to the selected port; and
(d) logging the signal, the first set of data and the second set of data.

2. A method for passively monitoring the servicing of a vehicle during distribution of fluid products thereto as recited in claim 1, wherein steps (a) through (d) are repeated until service of each port on a vehicle is complete.

3. A method for passively monitoring the servicing of a vehicle during distribution of fluid products thereto as recited in claim 1, wherein a horn is actuated by the signal to validate selection of the port as the intended port.

4. A method for passively monitoring the servicing of a vehicle during distribution of fluid products thereto as recited in claim 1, wherein the signal causes the sounding of an alarm, the alarm warning of improper distribution of the product.

5. A computer program embodied on a computer readable medium for passively monitoring the servicing of a vehicle during distribution of fluid products thereto comprising:
(a) a code segment that causes a first set of data, associated with a particular vehicle port to be serviced, to be obtained;
(b) a code segment that causes a determination of whether or not said first set of data identifies a particular port intended to be serviced and that causes a signal to be generated commensurate therewith;
(c) a code segment that causes a second set of data, associated with distribution of a product to the selected port, to be obtained; and
(d) a code segment that causes the signal, the first set of data and the second set of data to be logged.

6. A computer program for passively monitoring the servicing of a vehicle during distribution of fluid products thereto as recited in claim 5, wherein a code segment causes the code segments performing steps (a) through (d) to repeat until service of the vehicle is complete.

7. A computer program for passively monitoring the servicing of a vehicle during distribution of fluid products thereto as recited in claim 5, wherein said signal activates a horn to validate selection of the port as the intended port.

8. A computer program for passively monitoring the servicing of a vehicle during distribution of fluid products thereto as recited in claim 5, wherein the signal causes the sounding of an alarm, the alarm warning of improper distribution of the product.

9. A system for passively monitoring the servicing of a vehicle during distribution of fluid products thereto comprising:
(a) indicia providing a first set of data associated with a particular vehicle port to be serviced;
(b) logic that determines whether or not said first set of data identifies a particular port intended to be serviced and that generates a signal commensurate therewith;
(c) apparatus for generating a second set of data associated with distribution of a product to the selected port; and
(d) logic that logs the signal, the first set of data and the second set of data.

10. A system for passively monitoring the servicing of a vehicle during distribution of fluid products thereto as recited in claim 9, wherein logic causes the logic performing steps (a) through (d) to repeat until service of the vehicle is complete.

11. A system for passively monitoring the servicing of a vehicle during distribution of fluid products thereto as recited in claim 9, wherein a horn is actuated by the signal, to validate selection of the port as the intended port.

12. A system for passively monitoring the servicing of a vehicle during distribution of fluid products thereto as recited in claim 9, wherein the signal causes the sounding of an alarm, the alarm warning of improper distribution of the product.

13. An apparatus for passively monitoring the servicing of a vehicle during distribution of fluid products to fill ports on the vehicle, comprising:
a port identifying means associated with each port on a vehicle to be serviced, said identifying means containing port data relating to the identity of the vehicle and the identity of the port;
reader means for reading said port data and transmitting same to a remote receiver;
flow monitoring means associated with said remote receiver and the source of each fluid to be distributed and operative to generate flow data indicating the fluid source, the type of fluid to be dispensed from said fluid source, and the volume of fluid actually dispensed from said fluid source;
means for comparing said port data to said flow data and operative to generate an alarm in the event that any aspect of said port data is incompatible with any aspect of said flow data; and
means for producing a record of said port data, said flow data and the fact that an alarm was generated.

14. An apparatus as recited in claim 13, wherein said identifying means further contains port data relating to the type of material to be distributed to the port.

15. An apparatus as recited in claim 13, wherein the flow monitoring means includes a lookup table identifying the type of material to be put into a particular port.

16. An apparatus as recited in claim 13, and further comprising means for determining the location of said vehicle to be serviced and the time of servicing, and for reporting same to said means for producing a record whereby such location is included in said record.

17. An apparatus as recited in claim 13, wherein said port identifying means includes an array of indicators organized so that when inspected, a set of code terms can be developed uniquely identifying said vehicle, said port and said type of material to be distributed to said port.

18. An apparatus as recited in claim 13, wherein said reader means is further operative to generate operator data identifying the operator responsible for servicing said vehicle, and to transmit said operator data to said remote receiver.

19. An apparatus as recited in claim 14, wherein said port identifying means includes an array of indicators organized so that when inspected, a set of code terms can be developed uniquely identifying said vehicle, said port and said type of material to be distributed to said port.

20. An apparatus as recited in claim 14, wherein said reader means is further operative to generate operator data identifying the operator responsible for servicing said vehicle and for transmitting said operator data to said remote receiver.

21. An apparatus as recited in claim 15, wherein said reader means is further operative to generate operator data identifying the operator responsible for servicing said vehicle and for transmitting said operator data to said remote receiver.

22. A method of passively monitoring the servicing of a vehicle during distribution of fluid products to fill ports on the vehicle, comprising the steps of:
identifying each port on a vehicle to be serviced, by providing identifying means proximate each said port containing port data relating to the identity of the vehicle and the identity of the port;
reading said port data and transmitting same to a remote receiver;
monitoring the source of each fluid to be distributed and generating flow data indicating the fluid source, the type of fluid to be dispensed from said fluid source, and the volume of fluid actually dispensed from said fluid source;
comparing said port data to said flow data and generating an alarm in the event that any aspect of said port data is incompatible with any aspect of said flow data; and
producing a record of said port data, said flow data and the fact that an alarm was generated.

23. A method as recited in claim 22, wherein the identifying means proximate each said port further contains port data relating to the type of material to be distributed to the port.

24. A method as recited in claim 22, wherein monitoring the source of each fluid further comprises accessing a lookup table identifying the type of material to be put into a particular port.

25. A method as recited in claim 22, and further comprising the steps of determining the location of said vehicle to be serviced and the time of servicing, and reporting same for producing a record whereby such location is included in said record.

26. A method as recited in claim 22, and further comprising the step of generating operator data identifying the operator responsible for servicing said vehicle and transmitting said operator data to said remote receiver.
